(19) United States
(12) Patent Application Publication
(10) Pub. No.: US 2014/0019199 A1
(43) Pub. Date: Jan. 16, 2014

(54) AUTOMATICALLY EVALUATING CUSTOMER SATISFACTION

(71) Applicants: Ana Paula Appel, Sao Paulo (BR); Maira Athanazio De Cerqueira Gatti, Rio de Janeiro (BR); Rogerio Abreu De Paula, Sao Paulo (BR)

(72) Inventors: Ana Paula Appel, Sao Paulo (BR); Maira Athanazio De Cerqueira Gatti, Rio de Janeiro (BR); Rogerio Abreu De Paula, Sao Paulo (BR)

(73) Assignee: International Business Machines Corporation, Armonk, NY (US)

(21) Appl. No.: 13/548,727

(22) Filed: Jul. 13, 2012

(51) Int. Cl. G06Q 30/02

(52) U.S. Cl. 705/7.29

(57) ABSTRACT

A method for evaluating a satisfaction of a customer in a retail environment includes identifying an item for which the customer is searching in the retail environment, monitoring an activity of the customer with respect to the item in the retail environment, and automatically evaluating the satisfaction of the customer based on the activity of the customer with respect to the item.

### BACKGROUND OF THE INVENTION

The present invention relates generally to retail analytics and relates more specifically to evaluating customer satisfaction in retail environments.

Retail environments often use information relating to customer satisfaction to improve the quality of their customer service (and therefore improve sales). Customer satisfaction, however, is intangible and therefore difficult to evaluate objectively. Conventional methods for assessing customer satisfaction in a retail environment involve either gathering explicit customer feedback (e.g., via a survey) or directly monitoring the service-time customer experience. The effectiveness of these methods, however, is at least partially dependent on a level of voluntary customer participation. For instance, limited useful information can be obtained if a customer declines to respond to a survey. A retailer may thus be unaware that certain policies or practices are contributing to customer dissatisfaction (and possibly lost sales), and will therefore be unable to improve service accordingly.

### SUMMARY OF THE INVENTION

A method for evaluating a satisfaction of a customer in a retail environment includes identifying an item for which the customer is searching in the retail environment, monitoring an activity of the customer with respect to the item in the retail environment, and automatically evaluating the satisfaction of the customer based on the activity of the customer with respect to the item.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for automatically evaluating customer satisfaction, according to the present invention;

FIG. 2 is a flow diagram illustrating one embodiment of a method for automatically evaluating customer satisfaction, according to the present invention; and

FIG. 3 is a high-level block diagram of the customer satisfaction evaluation method that is implemented using a general purpose computing device.

### DETAILED DESCRIPTION

In one embodiment, the invention is a method and apparatus for automatically evaluating customer satisfaction. Embodiments of the invention automatically generate a measure of a customer's satisfaction in a retail environment, without requiring the customer to provide explicit feedback. In one embodiment, the invention employs a plurality of devices distributed across the retail environment. These devices allow customers to search for specific products within the retail environment by presenting information about the products and the retail environment. In addition, the devices record the customers' explicit and implicit responses to the presented information, and use the responses to infer the customers' satisfaction.

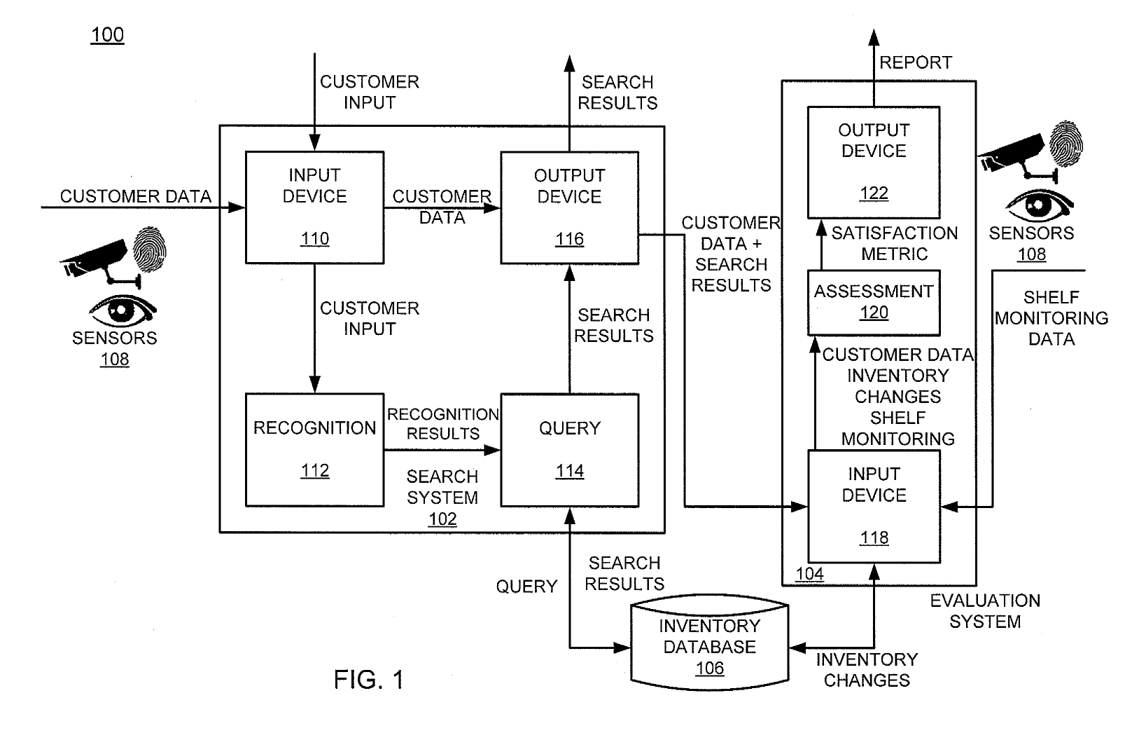

FIG. 1 is a block diagram illustrating one embodiment of a system 100 for automatically evaluating customer satisfaction, according to the present invention. Embodiments of the system 100 rely on automatic identification and data capture techniques to evaluate customer behavior and draw conclusions therefrom.

In one embodiment, the system 100 includes four main components: a search system 102, an evaluation system 104, an inventory database 106, and a plurality of sensors 108. These components 102-108 cooperate to automatically detect customer satisfaction as disclosed in greater detail below.

The search system 102 receives customer inputs relating to products and produces information about the products for the customer to review. To this end, the search system 102 comprises at least one input device 110, a recognition system 112, a query system 114, and at least one output device 116. In one embodiment, the search system 102 is a standalone device located within the retail environment (e.g., a kiosk or console). In this case, any of the system components 110-116 may comprise a processor configured to perform specific functions related to automatically detecting customer satisfaction. In another embodiment, an application downloaded to the customer's mobile device (e.g., cellular phone, tablet computer, portable gaming system, or the like) allows the customer's mobile device to function as the search system 102 and to interact with the evaluation system 104, the inventory database 106, and the sensors 108 as necessary.

The input device 110 comprises any device capable of receiving customer inputs related to products for which the customer wishes to search. To this end, the input device 110 may be multi-modal and may include any one or more of: a keyboard, a touch screen, a microphone or transducer, an imaging sensor, a motion sensor, a pointing device, a high-degree of freedom input device, a composite device, a barcode or image scanner, a smart card reader, a network interface, or the like.

The recognition system 112 is coupled to the input device 110 and processes the customer inputs in order to parse the customer's intent therefrom. In other words, the recognition system 112 determines, based on the customer input, for what the customer is searching. To this end, the recognition system 112 may include any one or more of: a natural language processor, a speech recognition processor, an optical character recognition processor, or the like. Thus, the recognition system may produce recognition results in the form of a string of searchable entities (i.e., recognized words, phrases, characters, or images) parsed from the customer input (e.g., a product brand name, a generic product name, or the like). In one embodiment, the recognition system 112 further comprises one or more pre-processing systems for performing pre-processing techniques to facilitate recognition processing. For instance, the recognition system 112 may include a system configured to perform endpointing, noise reduction, skew, motion, or blur compensation, or the like on the customer inputs.

The query system 114 is coupled to the recognition system 112 and processes the recognition results in order to formulate and execute a query to the inventory database 106. Thus, the query system 114 formats the recognition results into a searchable query that can be submitted to the inventory database 106. In turn, the inventory database 106 returns to the query system 114 search results including information about any products in the retail environment's inventory that match the query.

The query system 114 is further coupled to the output device 116 and forwards the search results from the inventory database 106 to the output device 106. In turn, the output device 116 presents the search results to the customer. To this end, the output device 116 may comprise any one or more of: a display device, a speaker, a printer, a haptic feedback device, a network interface, or the like.

In addition, the input device 110 is also connected to the output device 116. The input device 110 provides to the output device 116 identifying customer data (i.e., data that will assist in identifying and/or tracking the customer through the retail environment). This identifying data may be provided explicitly by the customer in the customer input, or may be implicitly obtained by the input device 110 through a subscription to the output of one or more of the sensors 108 (e.g., by capturing an image, biometric data, an identification or account number, or other identifying information). The output device 116 in turn provides this customer data to the evaluation system 104, as discussed in further detail below.

The evaluation system 104 compares the search results forwarded by the search system 102 with information about the customer's behavior in order to make an inference about the customer's satisfaction. To this end, the evaluation system 104 comprises an input device 118, an assessment system 120, and an output device 122. any of the system components 118-122 may comprise a processor configured to perform specific functions related to automatically detecting customer satisfaction.

The input device 118 comprises any device capable of receiving data from various sources. In one embodiment, the input device 118 receives one or more of: customer data and search results from the output device 116 of the search system 102, inventory changes from the inventory database 106, and shelf monitoring data from the sensors 108. To this end, the input device 118 may be multi-modal and may include any one or more of a keyboard, a touch screen, a microphone or transducer, an imaging sensor, a motion sensor, a pointing device, a high-degree of freedom input device, a composite device, a barcode or image scanner, a smart card reader, a network interface, or the like.

The assessment system 120 is coupled to the input device and processes the received inputs in order to evaluate the customer's satisfaction. In one embodiment, the assessment system 120 computes a satisfaction metric that is based on a number of factors, including the products for which the customer searched and the products that the customer actually bought. In one embodiment, the assessment system also tracks the customer's activities through the retail environment by correlating information received from the input device 118.

The output device 122 is coupled to the assessment system 120 and comprises any device capable of receiving the satisfaction metric and outputting the satisfaction metric as a report (e.g., to a computerized system or a human manager). To this end, the output device 122 may comprise any one or more of: a display device, a speaker, a printer, a haptic feedback device, a network interface, or the like.

As discussed above, the system 100 includes a plurality of sensors 108 that provide data for processing by various components. These sensors 108 may include one or more of: imaging sensors (e.g., still cameras, video cameras, or the like) or biometric sensors (e.g., fingerprint sensors, ocular sensors, voice sensors, or the like). These sensors 108 collect data from various physical locations within the retail environment. For instance, any one or more of the sensors 108 may be positioned to collect data at the entrances and exits of the retail environment, from locations where searches for items are performed, from individual sections, aisles, or shelves of the retail environment, from the cashier stations of the retail environment, or from any other location.

Although the system 100 is illustrated as comprising a plurality of individual components that perform discrete functions, it will be appreciated that any two or more of the illustrated components may be combined in a single component that performs multiple functions. Additionally, although the system 100 is illustrated as a contained system, it will be appreciated that the various components of the system 100 may be physically distributed throughout the retail environment (although still contained within the physical boundaries of the retail environment), and some of the components may even be located off-site (i.e., outside the physical boundaries of the retail environment). To this end, the various components of the system 100 may include a combination of wireless and physically connected devices.

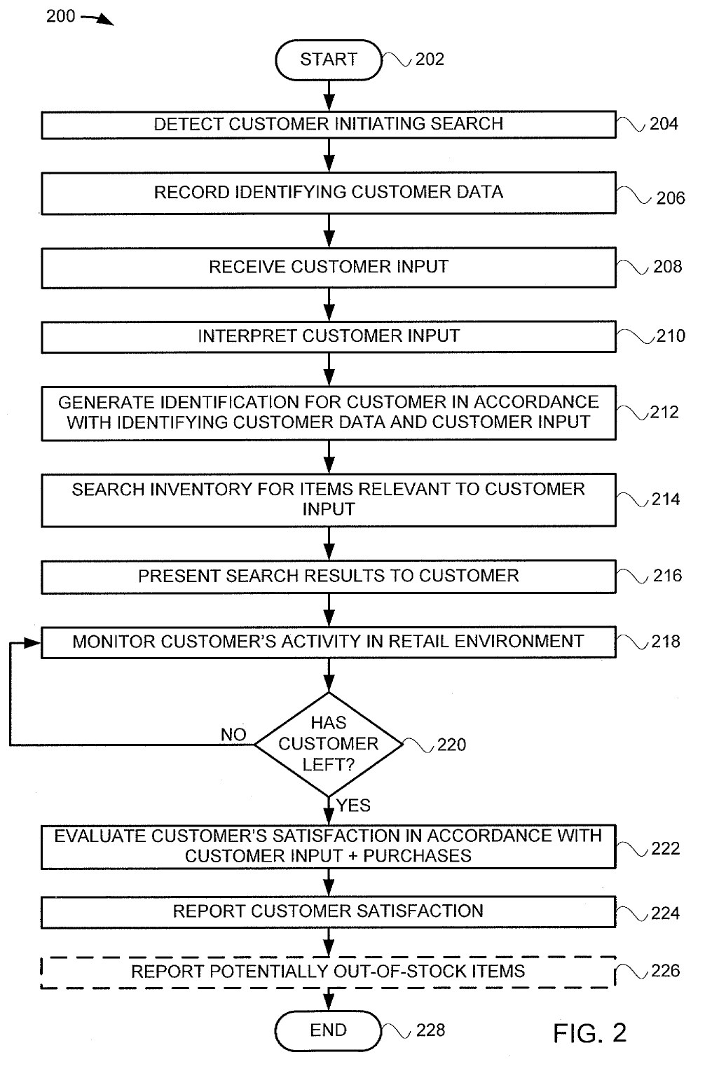

FIG. 2 is a flow diagram illustrating one embodiment of a method 200 for automatically evaluating customer satisfaction, according to the present invention. The method 200 may be performed, for example, by the system 100 illustrated in FIG. 1. As such, reference is made in the discussion of the method 200 to various elements depicted in FIG. 1. However, it will be appreciated that the method 200 may also be performed by systems having alternate configurations.

The method 200 begins at step 202 and proceeds to step 204, where the system 100 detects a customer initiating a search in a retail environment (e.g., a grocery store, a department store, a convenience store, or the like). In one embodiment, the initiation of the search is detected when the customer interacts with a standalone device (e.g., a kiosk or console) located in the retail environment. For instance, the customer may push a button or touch a location on a touch screen that indicates that she wishes to start a new search. In another embodiment, the initiation of the search is detected when the customer launches a search application on her mobile device.

In step 206, the input device 110 records identifying data about the customer. For instance, the input device 110 may receive substantially real-time data collected by one or more of the sensors 108 that allows the system 100 to uniquely identify the customer. This data may include, for example, still and/or video images of the customer, which would allow the system 100 to identify the customer by her appearance. Alternatively, the data may include biometric data, which would allow the system to identify the customer by one or more of her individual features (e.g., fingerprints, ocular features, gait).

In step 208, the input device receives customer input relating to an item for which the user wishes to search. For instance, the input may be received as an utterance (e.g., spoken into a microphone), a text string (e.g., input via a keyboard or touch screen), a selection on a touch screen (e.g., the customer touches a displayed image or name of a particular item), or in another form. The input identifies an item for which the user wishes to search, possibly by a specific brand name (e.g., Brand X shampoo) or by a generic product name (e.g., whole wheat pasta).

In step 210, the recognition system 112 interprets the customer input in order to determine for what the customer is searching. As discussed above, this step may involve one or more of: natural language processing, speech recognition processing, optical character recognition processing, or the like. Thus, the interpreting may result in a string of searchable entities (i.e., recognized words, phrases, characters, or images).

In step 212, the query system 114 generates an identification for the customer in accordance with the identifying information and the customer input. The identification uniquely associates the specific customer with the items for which she is searching, as well as allows the system 100 to track the customer's actual purchase for later comparison (as discussed in greater detail below). In one embodiment, the identification includes no sensitive personal information (e.g., does not include the customer's name or address). However, the identification may include some identifying information that allows the customer to be tracked (e.g., an image or biometric feature, or machine readable data such as a customer account number).

In step 214, the query system 114 performs a search of the inventory database 106. In particular, the query system 114 searches the inventory of the retail location for items relevant to the customer input, by using the string of searchable entities to formulate a query to the inventory database 106. If no exact match is found in the inventory database 106, the query system 114 may identify potential alternatives (e.g., Brand Y shampoo instead of Brand X shampoo).

In step 216, the output device 116 presents the search results to the customer. In one embodiment, the search results include an entry for each item in the inventory database 106 that is potentially relevant to the customer's input. In an alternative embodiment, the search results include entries for the top n items that are considered most relevant according to some method of evaluation. In one embodiment, the entry for each item includes one or more of the following: the name of the item, an image of the item, customer reviews of the item (e.g., numerical ratings or free-four feedback), the item's location in the retail environment (e.g., aisle number, section name, etc.), the item's price, and any promotional deals, sales, or coupons that relate to the item (e.g., fifty percent off). The search results may be output in visual form (e.g., on a display or a printed printed), audio form (e.g., via a speaker), tactile or haptic form (e.g., via a Braille interface), or other form. In another embodiment, the search results may be sent to the customer's mobile device (e.g. via a network interface).

In step 218, the assessment system 120 monitors the customer's activity in the retail environment. In one embodiment, the monitoring involves correlating data that identifies the customer from various locations within the retail environment, such as data provided by the sensors 108.

In step 220, the assessment system 120 determines whether the customer has left the retail environment. In one embodiment, the assessment system reviews the output of one or more of the sensors 108 in order to determine whether the customer has left.

If the assessment system 120 concludes in step 220 that the customer has not left the retail environment, then the method 200 returns to step 216, and the assessment system 120 continues to monitor the customer's activity as described above.

Alternatively, if the assessment system 120 concludes in step 220 that the customer has left the retail environment, then the method 200 proceeds to step 222, where the assessment system 120 evaluates the customer's satisfaction in accordance with any purchases she made before leaving the retail environment. In one embodiment, the evaluating involves correlating data that indicates for which items the customer searched, which areas of the retail environment the customer visits (e.g., in order to infer what items the customer reviews) and which items the customer purchases upon checkout. To this end, the assessment system 120 may correlate information from a variety of sources, including: the customer identification and search results generated by the query system 114, inventory changes from the inventory database 106 and/or from sensors 108 monitoring the cashier stations of the retail environment, or stock changes from sensors 108 monitoring the shelves, aisles, or sections of the retail environment, or other data from the sensors 108. In one embodiment, the correlating seeks in particular to identify: (1) items for which the customer searched and which the customer purchased (including alternative items suggested by the system 100); and (2) items for which the customer searched and which the customer did not purchase (including alternative items suggested by the system 100).

The assessment system 120 may use any one or more of a number of known techniques in order to produce a satisfaction metric that quantifies the customer's level of satisfaction. For instance, in one embodiment, the assessment system 120 may evaluate the customer's satisfaction based on a weighted combination of items searched for and purchased and items searched for and not purchased. In one embodiment, the satisfaction metric is a numerical indicator whose value falls within some defined range that indicates varying levels of satisfaction (e.g., a scale of one to ten, with one representing the lowest level of satisfaction and ten representing the highest level of satisfaction). In another embodiment, the satisfaction metric is non-numeric indicator falling on a rubric that indicates varying levels of satisfaction (e.g., satisfied/partly satisfied/not satisfied).

In step 224, the output device 122 reports the satisfaction metric. In one embodiment, the satisfaction metric is reported to another system that stores and/or monitors customer satisfaction information. In another embodiment, the satisfaction metric is reported to human manager or administrator for review.

In optional step 226 (illustrated in phantom), the output device 122 sends a report (e.g., to another system or to a human manager) identifying potentially out-of-shelf items. If a customer searches for an item but ultimately does not purchase the item, this may indicate that the item is out-of-shelf and needs to be re-stocked. Thus, an optional report can be generated to notify the appropriate personnel to review the inventory. Systems and methods for identifying out-of-shelf items are discussed in greater detail in U.S. patent application Ser. No. ______, filed ______ [Attorney Docket No. YOR920120345US1].

The method 200 ends in step 228.

The system 100 can thus be employed to automatically evaluate customer satisfaction with regard to the search for specific products through observation of customer behaviors (i.e., whether or not the customer make an expected purchase). Moreover, because this inference is drawn at least in part from observed customer behaviors, it does not require explicit feedback from the customer. Thus, the present invention allows a retail environment to improve its service to customers without subjecting the customers to burdensome surveys with which they may or may not agree to cooperate.

Although the method 200 is largely described within the context of the activities of a single customer, it is noted that the method 200 may be performed for every customer that is detected in the retail environment. Alternatively, the method 200 may be performed for a subset of the detected customers (e.g., only for customers who search for specific products).

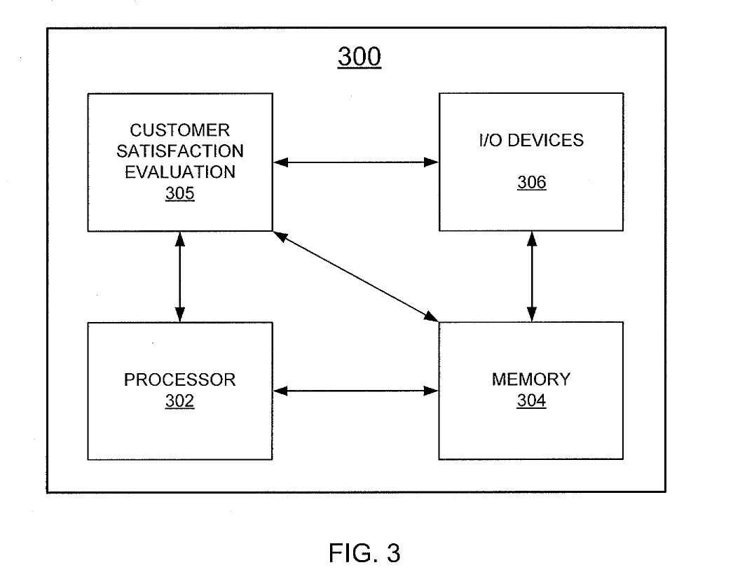

FIG. 3 is a high-level block diagram of the customer satisfaction evaluation method that is implemented using a general purpose computing device 300. In one embodiment, a general purpose computing device 300 comprises a processor 302, a memory 304, a customer satisfaction module 305 and various input/output (I/O) devices 306 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the customer satisfaction module 305 can be implemented as a physical device or subsystem that is coupled to a processor through a communication channel.

Alternatively, the customer satisfaction module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the customer satisfaction module 305 for evaluating customer satisfaction in a retail environment, as described herein with reference to the preceding figures, can be stored on a computer readable storage medium or device (i.e., a tangible or physical article such as RAM, a magnetic or optical drive or diskette, and the like, rather than a propagating signal).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

1. A method for evaluating a satisfaction of a customer in a retail environment, the method comprising:
identifying an item for which the customer is searching in the retail environment;
monitoring an activity of the customer with respect to the item in the retail environment, wherein the activity includes offline activity of the customer occurring between a point of search and a point of sale; and
automatically evaluating the satisfaction of the customer based on the activity of the customer with respect to the item,
wherein at least one of: the monitoring or the automatically evaluating is performed using a processor.

2. The method of claim 1, wherein the identifying comprises:
receiving an input from the customer;
recognizing a searchable entity in the input; and
locating the item in an inventory database, wherein the item is relevant to the searchable entity.

3. The method of claim 2, wherein the item is an exact match to an item indicated by the searchable entity.

4. The method of claim 2, wherein the item is an alternative to an item indicated by the searchable entity.

5. The method of claim 2, wherein the searchable entity is a word.

6. The method of claim 2, wherein the searchable entity is a phrase.

7. The method of claim 2, wherein the searchable entity is a character.

8. The method of claim 2, wherein the searchable entity is an image.

9. The method of claim 1, wherein the monitoring comprises:
capturing data that uniquely identifies the customer;
generating an identification for the customer in accordance with the data, wherein the identification facilitates the monitoring; and
associating the item with the identification.

10. The method of claim 9, wherein the data is an image of the customer.

11. The method of claim 9, wherein the data is a biometric feature of the customer.

12. The method of claim 1, wherein the automatically evaluating comprises:
detecting whether the customer purchased the item; and
inferring the satisfaction based on whether the customer purchased the item.

13. The method of claim 12, further comprising:
reporting to a representative of the retail environment that the item may be out-of-shelf when the customer does not purchase the item.

14. The method of claim 1, further comprising:
reporting a metric that quantifies the satisfaction.

15. The method of claim 14, wherein the metric is a numerical indicator having a value that falls within a defined range that indicates varying levels of satisfaction.

16. The method of claim 14, wherein the metric is a non-numeric indicator that falls on a rubric that indicates varying levels of satisfaction.

17. The method of claim 14, wherein the metric is a computed result of a weighted average.

18. The method of claim 1, wherein the processor is part of a mobile device used by the customer.

19. The method of claim 1, wherein the automatically evaluating is performed without receiving explicit feedback from the customer relating to the satisfaction.

20. A method for evaluating a satisfaction of a customer in a retail environment, the method comprising:
capturing data that uniquely identifies the customer;
generating an identification for the customer in accordance with the data;
receiving an input from the customer;
identifying an item in an inventory of the retail environment that is relevant to the input;
associating the item with the identification;
monitoring an activity of the customer in the retail environment, using the identifier, wherein the activity includes offline activity of the customer occurring between a point of item search and a point of sale;
detecting when the customer leaves the retail environment; and
automatically evaluating the satisfaction of the customer based at least in part on whether the customer purchases the item before leaving the retail environment,
wherein at least one of: the capturing, the generating, the identifying, the associating, the monitoring, the detecting, or the automatically evaluating is performed using a processor.
